(19) United States
(12) Patent Application Publication
(10) Pub. No.: US 2010/0265991 A1
(43) Pub. Date: Oct. 21, 2010

(54) RECEIVING APPARTUS, RECEIVING METHOD, PHASE TRACKING APPARATUS, AND PHASE TRACKING METHOD OF PULSE-BASED UWB WIRELESS SYSTEM

(76) Inventors: Mi Kyung Oh, Gyeongsangbuk-do (KR); Jung Yeol Oh, Daejeon (KR); Min Su Kil, Chungcheongnam-do (KR); Jae Young Kim, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/747,462

(22) PCT Filed: Aug. 21, 2008
(86) PCT No.: PCT/KR2008/004888

§ 371 Date: Jun. 10, 2010

(30) Foreign Application Priority Data
Dec. 11, 2007 (KR) 10-2007-0128547

(51) Int. Cl. H04B 1/69

(52) U.S. Cl. 375/130; 375/E01.001

(57) ABSTRACT

Provided are a receiving apparatus, a receiving method, a phase tracking apparatus, and a phase tracking method of a pulse-based UWB wireless system, which are capable of tracking and compensating phases of signals modulated with different modulation schemes in the same pulse-based UWB receiver system. The receiving apparatus of the UWB wireless system includes an orthogonal channel generating unit for receiving a baseband signal to generate orthogonal channels, a boundary detecting unit for receiving output signals of the orthogonal channel generating unit to detect boundaries of preamble, header and payload signals, a phase tracking unit for tracking and compensating phases of the preamble, header and payload signals output from the boundary detecting units, and a demodulating unit for demodulating output signals of the boundary detecting unit and the phase tracking unit to output data bits.

### TECHNICAL FIELD

The present disclosure relates to a receiving apparatus, a receiving method, a phase tracking apparatus, and a phase tracking method of a pulse-based ultra-wideband (UWB) wireless system, and more particularly, to a receiving apparatus, a receiving method, a phase tracking apparatus, and a phase tracking method of a pulse-based UWB wireless system, which are capable of tracking and compensating phases of signals modulated with different modulation schemes in the same pulse-based UWB receiver system.

This work was supported by the IT R&D program of MIC/IITA. [2006-S-070-02, Development of Cognitive Wireless Home Networking System]

### BACKGROUND ART

Pulse-based UWB wireless technology is attracting much attention as the promising technology because of its low power implementation and inherent distance estimation capabilities. The pulse-based UWB wireless technology was adopted as the physical layer technology of the IEEE 802.15.4a, the international standard of a low-rate location-aware Wireless Personal Area Network (WPAN), in March 2007.

FIG. 1 illustrates an IEEE 802.15.4a pulse-based UWB frame. Referring to FIG. 1, as opposed to a wireless system using successive signals, the IEEE 802.15.4a pulse-based UWB wireless system employs a pulse with a pulse with of several nanoseconds to perform a modulation 104 using a ternary code {1, 0, −1} at a preamble section 100 and 101 and perform a burst position modulation (BPM), which is one of pulse position modulations, and a binary phase shift keying (BPSK) modulation at header and payload sections 102 and 103.

FIG. 2 illustrates a BPM+BPSK modulation scheme in a pulse-based UWB wireless system. Referring to FIG. 2, the BPM+BPSK modulation maps 2 bits into 1 symbol. Of the 2 bits, 1 bit is mapped into a position of the pulse and 1 bit is mapped into a polarity of the pulse. For example, in the case of “00” in FIG. 2(a), a positive pulse 200 is positioned at the head of the symbol period. In the case of “01” in FIG. 2(b), a positive pulse 201 is positioned at the tail of the symbol period. In the case of “10” in FIG. 2(c), a negative pulse 202 is positioned at the head of the symbol period. In the case of “11” in FIG. 2(d), a negative pulse 203 is positioned at the tail of the symbol period. The pulse signal may be one pulse signal or a set of pulses.

In order to recover the symbol into the 2-bit signal, a metric as to whether the position of the pulse is 0 (referred to as BPM0) or 1 (BPM1) should be calculated, and information as to whether the polarity of the pulse is + or − should be calculated.

Generally, in the UWB system, a polarity-modulated transmit (TX) signal is received by an antenna over a wireless channel and is then down-converted by an RF module. Then, the down-converted signal is recovered. At this point, signal degradation is caused by the instability of the RF module. One of the causes is a mismatch between an in-phase (I) channel and a quadrature (Q) channel. The mismatch between the I-channel and the Q-channel is caused because an exact 90-degree phase difference is not provided between the I-channel and the Q-channel. Since such a phase distortion is accumulated with time, the received signal rotates in the constellation so that the bit stream of 0 and 1 is not correctly recovered.

Therefore, the pulse-based UWB receiver system must track and appropriately compensate the phase of the received signal in order to recover the signal that has been polarity-modulated at the preamble section and the header and payload sections. That is, the pulse-based UWB receiver system must know a polarity of a ternary code correlation value at the preamble section in order to detect a start frame delimiter (SFD) signal (e.g., 8 ternary-code symbols (0, 1, 0, −1, 1, 0, 0, −1)). Also, the pulse-based UWB receiver system must know a polarity of a despread value at the header and payload sections in order to demodulate the BPSK signal.

Since the IEEE 802.15.4a UWB system aims at a low-complexity distance estimation/communication system, it is necessary to design a low-complexity phase tracking apparatus.

Therefore, the phase tracking apparatus needs to be designed, considering the fact that the signal modulation schemes are different at the preamble section and the header and data sections in the IEEE 802.15.4a UWB frame.

### DISCLOSURE OF INVENTION

### Technical Problem

Therefore, an object of the present invention is to provide a receiving apparatus, a receiving method, a phase tracking apparatus, and a phase tracking method of a pulse-based UWB wireless system, which are capable of tracking and compensating phases of signals modulated with different modulation schemes in the same pulse-based UWB receiver system.

### Technical Solution

To achieve these and other advantages and in accordance with the purpose(s) of the present invention as embodied and broadly described herein, a receiving apparatus of a pulse-based UWB wireless system in accordance with an aspect of the present invention includes: an orthogonal channel generating unit for receiving a baseband signal to generate orthogonal channels; a boundary detecting unit for receiving output signals of the orthogonal channel generating unit to detect boundaries of preamble, header and payload signals; a phase tracking unit for tracking and compensating phases of the preamble, header and payload signals output from the boundary detecting units; and a demodulating unit for demodulating output signals of the boundary detecting unit and the phase tracking unit to output data bits.

The boundary detecting unit may include: a cross-correlator for detecting the boundary of the preamble signal using a ternary code; and a despreader for detecting the boundary of the header and payload signals using a spreading code.

The demodulating unit may include: a start field delimiter (SFD) detector for detecting an SFD detection control signal from the output signal of the phase tracking unit; a binary phase shift keying (BPSK) soft-decider for demodulating a BPSK signal from the output signals of the phase tracking unit; and a burst position modulation (BPM) soft-decider for demodulating a BPM signal from the output signals of the boundary detecting unit.

To achieve these and other advantages and in accordance with the purpose(s) of the present invention, a phase tracking apparatus of a pulse-based UWB wireless system in accordance with another aspect of the present invention includes: first and second multipliers for multiplying input signals by a previous phase tracking result; a selector for calculating absolute values of phase-compensated input signal and selecting the greatest one of the absolute values; first and second comparators for comparing the selected absolute value with a threshold value, and comparing if a real part is greater than zero when the selected absolute value is greater than the threshold value; a phase shifter for shifting a phase of the signal when the real part output from the second comparator is less than zero; a third multiplier for accumulating the phase by multiplying the phase-shifted value by a value calculated at a previous symbol time; a normalizer for normalizing the accumulated value; and a conjugate complex number generator for calculating a weighted mean value of the normalized signal and generating a conjugate complex number of a phase tracking result.

To achieve these and other advantages and in accordance with the purpose(s) of the present invention, a receiving method of a pulse-based UWB wireless system in accordance with another aspect of the present invention includes: receiving a baseband signal to generate orthogonal channels; receiving output signals of the orthogonal channel generating unit to detect boundaries of preamble, header and payload signals; tracking and compensating phases of the preamble, header and payload signals output from the boundary detecting units; and demodulating output signals of the phase tracking unit to output data bits.

To achieve these and other advantages and in accordance with the purpose(s) of the present invention, a phase tracking method of a pulse-based UWB wireless system in accordance with another aspect of the present invention includes: calculating magnitudes of two complex numbers of an input signal; comparing the magnitudes of the two complex numbers and selecting the greater one of the magnitudes of the two complex numbers; comparing if the selected value is greater than a threshold value; comparing if a real part is greater than zero when the selected value is greater than the threshold value, and outputting the real part to a positive real axis; multiplying the result value by a phase tracking value of a previous symbol period; normalizing the multiplication result value; calculating a weighted mean value of the normalized value; generating a conjugate complex number of the weighted mean value; and compensating a phase error by multiplying the generated conjugate complex number by the input signal.

When the selected value is not greater than the threshold value, a phase tracking value of a current time may be estimated and compensated by converting a phase tracking value estimated at a previous symbol step as much as a real-time symbol time, or the phase tracking value of the current time may be compensated by estimating a real-time phase tracking value from a previously calculated frequency offset estimation value.

### ADVANTAGEOUS EFFECTS

A receiving apparatus, a receiving method, a phase tracking apparatus, and a phase tracking method of a pulse-based ultra-wideband (UWB) wireless system are capable of tracking and compensating phases of signals modulated with different modulation schemes in the same pulse-based UWB receiver system.

### BRIEF DESCRIPTION OF THE DRAWINGS

FIG. 1 illustrates an IEEE 802.15.4a pulse-based UWB frame.

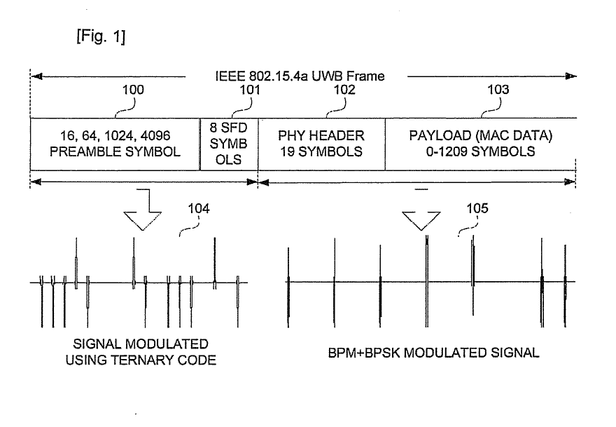

FIG. 2 illustrates a BPM+BPSK modulation scheme in a pulse-based UWB wireless system.

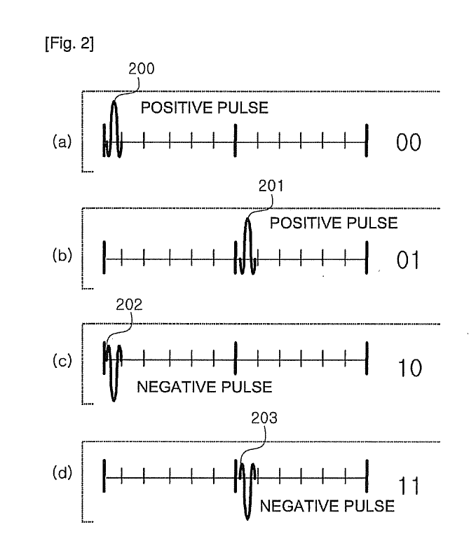

FIG. 3 is a block diagram illustrating a receiving apparatus of a pulse-based UWB wireless system according to an embodiment of the present invention.

FIG. 4 is a flowchart illustrating a receiving method of a pulse-based UWB wireless system according to an embodiment of the present invention.

FIG. 5 illustrates a structure of a phase tracking apparatus according to an embodiment of the present invention.

FIG. 6 illustrates a process of normalizing a complex number.

FIG. 7 is a flowchart illustrating a phase tracking method according to an embodiment of the present invention.

### BEST MODE FOR CARRYING OUT THE INVENTION

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

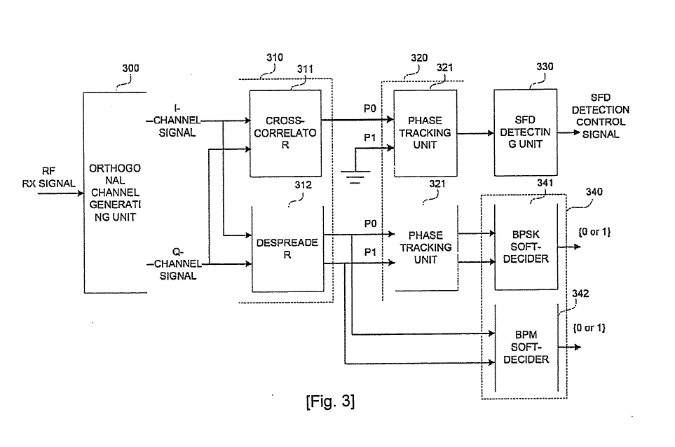

FIG. 3 is a block diagram illustrating a receiving apparatus of a pulse-based UWB wireless system according to an embodiment of the present invention. Referring to FIG. 3, the receiving apparatus of the pulse-based UWB wireless system based on IEEE 802.15.4a is configured to recover a BPM signal and a BPSK signal. The receiving apparatus of the pulse-based UWB wireless system includes an orthogonal channel generating unit 300, a boundary detecting unit 310, a phase tracking unit 320, and a demodulating unit 340. The orthogonal channel generating unit 300 receives a baseband signal to generate orthogonal channels. The boundary detecting unit 310 receives the output signals of the orthogonal channel generating unit 300 and detects boundaries of preamble, header and payload signals. The phase tracking unit 320 tracks and compensates phases of the preamble, header and the payload signals output from the boundary detecting unit 310. The demodulating unit 340 demodulates the output signals of the boundary detecting unit 310 and the phase tracking unit 320 and outputs data bits.

More specifically, the orthogonal channel generating unit 300 receives an RF signal to output an I-channel signal and a Q-channel signal.

The boundary detecting unit 310 includes a cross-correlator 311 and a despreader 312. The cross-correlator 311 receives the I-channel signal and the Q-channel signal from the orthogonal channel generating unit 300 and detects the boundary of the preamble using a ternary code in order to find a preamble section. The despreader 312 receives the I-channel signal and the Q-channel signal and detects header and a payload sections using a spreading code.

The phase tracking unit 320 receives the output signals of the boundary detecting unit 310 and performs a phase compensation by multiplying them by a conjugate complex number of the phase tracking result.

The demodulating unit 340 includes, a BPSK soft-decider 341, and a BPM soft-decider 342. The SFD detector 330 detects an SFD detection control signal from the output signal of the phase tracking unit 320. The BPSK soft-decider 341 demodulates a BPSK signal from the output signal of the phase tracking unit 320, and the BPM soft-decider 342 demodulates a BPM signal from the output signal of the boundary detecting unit 310.

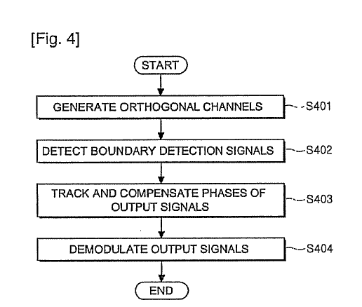

FIG. 4 is a flowchart illustrating a receiving method of the pulse-based UWB wireless system according to an embodiment of the present invention. Referring to FIG. 4, orthogonal channels are generated from a received baseband signal in operation S401. The orthogonal channels include an I-channel signal and a Q-channel signal.

In operation 5402, boundaries of preamble, header and payload signals are detected from the output signals of the orthogonal channel generating unit 300. That is, the boundary of the preamble section is detected using a ternary code, and the boundaries of the header and payload sections are detected using a spreading code.

In operation S403, the phases of the output signals are tracked and compensated. At this point, a single phase tracking unit may be used to compensate the phases of the output signals with respect to the preamble section and the header and payload sections.

In operation 5404, data bits are output by demodulating the output signals of the phase tracking unit 320. That is, in case where an SFD signal is detected and an SFD detection control signal is output, the signal of the preamble section determines that the header section is started, and the BPSK signal and the BPM signal are demodulated.

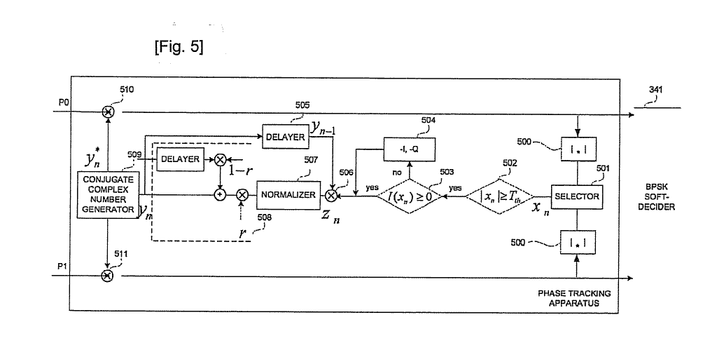

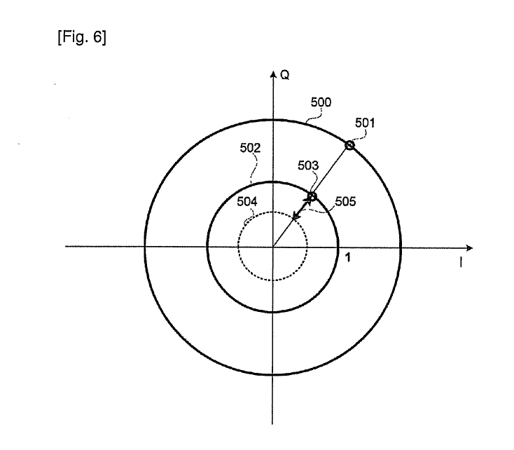

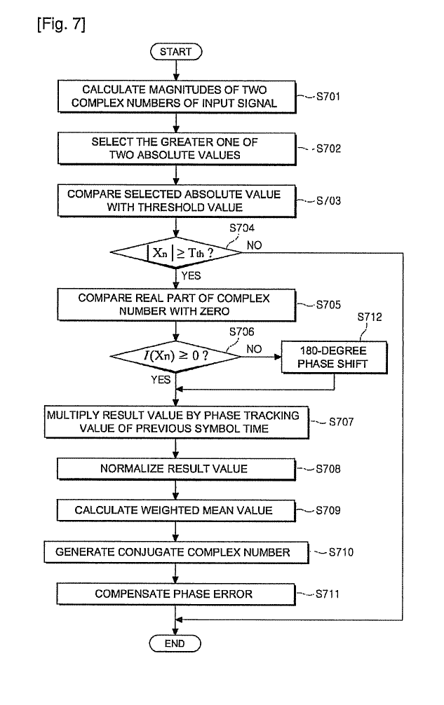

FIG. 5 illustrates a structure of a phase tracking apparatus according to an embodiment of the present invention. FIG. 6 illustrates a process of normalizing a complex number. FIG. 7 is a flowchart illustrating a phase tracking method according to an embodiment of the present invention. The phase tracking apparatus and the phase tracking method will be described below with reference to FIGS. 5 through 7.

In operation 5701, when the phase tracking apparatus receives two complex numbers P0 and P1, first and second multipliers 510 and 511 multiply the input signals by a phase tracking result obtained at a previous symbol time.

More specifically, the complex numbers P0 and P1 input to the phase tracking apparatus correspond to the output of the ternary code cross-correlator 311 at the preamble section, and correspond to the outputs of the despreader 312 at the header and payload sections. Since the despreader 312 simultaneously outputs the signals corresponding to BPM0 and BPM1, these signals must be input to the phase tracking apparatus. Since the pulse position modulation scheme is not performed at the preamble section, the ternary code cross-correlator 311 output a single output signal. At this point, “0” may be input as P1 at the preamble section in order to use the same phase tracking apparatus over the entire sections of the UWB packet.

Then, absolute values of the two complex numbers of the input signal are calculated. When the complex number is r=a+jb, its absolute value is

\sqrt{a²+b²}

. Since this is difficult to implement in hardware, the absolute value may be approximated to

|a|±|b|

. In operation S702, a selector compares the absolute values of the two complex numbers and selects the greater one of the two absolutes values. At this point, the selector outputs the complex number xₙ having the greater absolute value in order to use the greater one of the complex numbers P0 and P1 in the phase tracking. That is, it is impossible to know which one of the signals P0 and P1 is input, until the BPM+BPSK signal is demodulated. Thus, the side where the signal exists is selected.

In operation S703, a first comparator 502 compares if the selected absolute value is greater than a certain threshold value. More specifically, this process is performed for determining if the signal P0 or P1 input to the phase tracking apparatus is a reliable signal. The reliable signal represents a non-noise signal. That is, this process is performed for finding a non-zero symbol period that exists in the preamble section due to the characteristic of an IEEE 802.15.4a IR-UWB packet.

Meanwhile, if the selected absolute value is not greater than the certain threshold value, the phase tracking value with respect to a current time cannot be calculated. In this case, the phase tracking value of a current time can be estimated and compensated by converting a phase tracking value estimated at a previous symbol step as much as a real-time symbol time. Alternatively, the phase tracking value with respect to the current time can be compensated by estimating a real-time phase tracking value from a previously calculated frequency offset estimation value.

When the selected absolute value is greater than the certain threshold value in operation S704, a second comparator 503 compares a real part of the complex number xₙ with zero and determines if the real part is greater than zero in operation S705. More specifically, this process is performed for tracking the phase difference of the received signal around a positive real axis by comparing if the real part is greater than zero. The real part is output without phase shift when it is greater than zero in operation S706.

Meanwhile, when the real part of the selected complex number xₙ is negative, it is transposed to the positive real axis by 180-degree phase shift, so that the phase tracking can be performed on the positive real axis. The 180-degree ambiguity generated through this process can be compensated by the BPSK soft-decider using a known preamble signal.

In operation S707, a third multiplier 506 multiplies the result value by the phasetracking value of the previous symbol time. At this point, a process of multiplying yₙ₋₁ output through a delayer 505 has an effect that accumulates the phase difference. The multiplication result is expressed as Equation (1) below.

zₙ=yₙ₋₁xₙ=|yₙ₋₁|e^{j(θ}^{₀}^{+θ}^{₁}^{+ . . . +θ}^{_{n−1}}⁾|xₙ|e^{jtheta}^{ₙ}=|xₙ|e^{j(θ}^{₀}^{+θ}^{₁}^{+ . . . +θ}^{_{n−1}}⁾ (1)

In Equation (1), since yₙ₋₁ is a normal signal, its absolute value

|yₙ₋₁|

is 1 and its phase is equal to the accumulation of the phase estimation values from θ₀ (the phase tracking result when n=0) to θₙ₋₁ (the phase tracking result when n=n−1). Assuming that the absolute value of xₙ is greater than the certain threshold value and its real part is greater than zero, xₙ has a magnitude of

|xₙ|

and a phase of θₙ. Thus, xₙ is expressed as

|xₙ|e^{jθ}^{ₙ}

.

In operation 5708, a normalizer 507 normalizes the multiplication result value. More specifically, the normalizer 507 is a device that maintains an original phase of the signal and makes a magnitude of the signal “1”.

As illustrated in FIG. 6, the normalizer 507 maps a signal 501 to be normalized into a signal 503 of a unit circle 502, which has the same phase as the signal 501 and the magnitude of “1”. That is, the complex number r=a+jb is normalized as Equation (2) below.

$$\frac{a + jb}{\sqrt{{a}^{2} + {b}^{2}}} \qquad ( 2 )$$

Hardware implementation of the normalizer 507 requires a squarer, a square rooter, and a divider. Therefore, the normalization result uₙ of Equation (1) is expressed as Equation (3) below.

uₙ=e^{j(θ}^{₀}^{+θ}^{₁}^{+ . . . +θ}^{_{n−1}}⁾ (3)

In operation S709, a weighted mean value of the normalized value is calculated. This process is performed for reducing noise effect. Since the phase of the current input signal xₙ may become uncertain, weights are assigned to the previous phase tracking value and the current phase tracking value and the weighted values are summed, as expressed in Equation (4) below.

yₙ=(1−r)yₙ₋₁+ruₙ

(where

0≦r≦1) (4)

In Equation (4), if r=1, yᵤ=uₙ

A conjugate complex number of the weighted mean value is generated in operation S710, and the phase error is compensated by multiplying the conjugate complex number in operation S711.

A conjugate complex number generator 509 outputs the conjugate complex number yₙ* of the input complex number yₙ.

The normalizer 507 may be replaced with a low-complexity approximate normalizer. If the normalizer is implemented in hardware, its complexity generally increases. Thus, in a system requiring a low complexity, the low-complexity approximate normalizer can be applied in order to reduce the complexity of the phase tracking apparatus. The low-complexity approximate normalizer will be described below.

For example, it is assumed that a real part is greater than an imaginary part in the complex number; the real part “a” is represented with n bits; MSB 1 bit of the n bits represents a polarity of the real part “a”; p bits represent an integer part; and q bits represent a decimal fraction part. In this case, n=p+q+1. In the real part “a” represented by the n bits, a digit at which a bit of “1” appears at the first time, except for MSB, is found and a difference between the found digit and the first digit below the decimal point is obtained. The obtained difference is defined as “m”

As one example, assuming that a fixed-point 9-bit number is “010101000”, m=4 if p=4 and q=4.

As another example, assuming that a 9-bit number is “000000111”, m=−1 if p=4 and q=4. If the imaginary part is greater than the real part in the complex number, the value “m” is found by performing the above-described process on the imaginary part “b”. After finding the value “m”, a process of dividing the complex number by 2^{m} is carried out, as expressed in Equation (5) below.

$$\frac{a + jb}{{2}^{m}} \qquad ( 5 )$$

In Equation (5), 2^{m} is the greatest value that can be represented by the powers of 2 among the values equal to or less than

\sqrt{a²+b²}

. In hardware implementation of the above-described process, a right shift is taken when m is a positive number, and a left shift is taken when m is a negative number. Therefore, the approximate normalization process includes the process of finding “1” and the shifting process.

If the approximate normalization is carried out like Equation (5), the magnitude of the approximated result value does not become “1”. The magnitude of the approximated result value always varies depending on the values of “a” and “b”. Like “505” of FIG. 6, the magnitude of the approximated result value is greater than 0.5 and equal to or less than 1. If the approximate normalization is performed as above, the magnitude of the signal is reduced and the magnitude of noise is also reduced. Hence, a signal-to-noise ratio (SNR) does not change. This means that when the polarity of the BPSK signal is recovered, the magnitude of the signal does not influence the performance even though it is reduced.

If the conjugate complex number of the approximate-normalized value is multiplied by the input signal, its magnitude is reduced by up to 0.5 times. After the phase compensation, the BPSK soft-decider determines whether the value is “0” or “1”.

Although the first digit below the decimal point is found in the process of searching “1” upon the approximate normalization, the first digit of the integer part may also be found. In addition, after finding the two digits, a digit making the absolute value of the complex number close to “1” may be selected.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

### INDUSTRIAL APPLICABILITY

A receiving apparatus, a receiving method, a phase tracking apparatus, and a phase tracking method according to the present invention can track and compensate the phases of signals modulated with different modulation schemes in the same pulse-based UWB receiver system. Therefore, the present invention can be applied to the pulse-based UWB wireless systems or the like and can be used in the equivalent fields in various ways.

1. A receiving apparatus of a pulse-based ultra-wideband (UWB) wireless system, comprising:
an orthogonal channel generating unit for receiving a baseband signal to generate orthogonal channels;
a boundary detecting unit for receiving output signals of the orthogonal channel generating unit to detect boundaries of preamble, header and payload signals;
a phase tracking unit for tracking and compensating phases of the preamble, header and payload signals output from the boundary detecting units; and
a demodulating unit for demodulating output signals of the boundary detecting unit and the phase tracking unit to output data bits.

2. The receiving apparatus of claim 1, wherein the boundary detecting unit comprises:
a cross-correlator for detecting the boundary of the preamble signal using a ternary code; and
a despreader for detecting the boundary of the header and payload signals using a spreading code.

3. The receiving apparatus of claim 1, wherein the phase tracking unit receives the output signals of the boundary detecting unit and compensates the phases of the preamble, header and payload signals by multiplying a conjugate complex number of the phase tracking result.

4. The receiving apparatus of claim 1, wherein the demodulating unit comprises:
a start field delimiter (SFD) detector for detecting an SFD detection control signal from the output signal of the phase tracking unit;
a binary phase shift keying (BPSK) soft-decider for demodulating a BPSK signal from the output signals of the phase tracking unit; and
a burst position modulation (BPM) soft-decider for demodulating a BPM signal from the output signals of the boundary detecting unit.

5. A phase tracking apparatus of a pulse-based ultra-wideband (UWB) wireless system, comprising:
first and second multipliers for multiplying input signals by a previous phase tracking result;
a selector for calculating absolute values of phase-compensated input signal and selecting the greatest one of the absolute values;
first and second comparators for comparing the selected absolute value with a threshold value, and comparing if a real part is greater than zero when the selected absolute value is greater than the threshold value;
a phase shifter for shifting a phase of the signal when the real part output from the second comparator is less than zero;
a third multiplier for accumulating the phase by multiplying the phase-shifted value by a value calculated at a previous symbol time;
a normalizer for normalizing the accumulated value; and
a conjugate complex number generator for calculating a weighted mean value of the normalized signal and generating a conjugate complex number of a phase tracking result.

6. The phase tracking apparatus of claim 5, wherein the selector calculates an absolute value of a complex number of the phase-compensated signal and selects the greater one of magnitudes of a real part and an imaginary part.

7. A receiving method of a pulse-based ultra-wideband (UWB) wireless system, comprising:
receiving a baseband signal to generate orthogonal channels;
receiving output signals of the orthogonal channel generating unit to detect boundaries of preamble, header and payload signals;
tracking and compensating phases of the preamble, header and payload signals output from the boundary detecting units; and
demodulating output signals of the phase tracking unit to output data bits.

8. The receiving method of claim 7, wherein the generating of the orthogonal channels comprises generating an I-channel signal and a Q-channel signal.

9. A phase tracking method of a pulse-based ultra-wideband (UWB) wireless system, comprising:
calculating magnitudes of two complex numbers of an input signal;
comparing the magnitudes of the two complex numbers and selecting the greater one of the magnitudes of the two complex numbers;
comparing if the selected value is greater than a threshold value;
comparing if a real part is greater than zero when the selected value is greater than the threshold value, and outputting the real part to a positive real axis;
multiplying the result value by a phase tracking value of a previous symbol period;
normalizing the multiplication result value;
calculating a weighted mean value of the normalized value;
generating a conjugate complex number of the weighted mean value; and
compensating a phase error by multiplying the generated conjugate complex number by the input signal.

10. The phase tracking method of claim. 9, wherein when the selected value is not greater than the threshold value, a phase tracking value of a current time is estimated and compensated by converting a phase tracking value estimated at a previous symbol step as much as a real-time symbol time, or the phase tracking value of the current time is compensated by estimating a real-time phase tracking value from a previously calculated frequency offset estimation value.

11. The phase tracking method of claim 9, wherein the two complex numbers of the input signal comprises P0 and P1.

12. The phase tracking method of claim 9, wherein the real part is less than zero, the real part is transposed to the positive real axis by 180-degree phase shift.

13. The phase tracking method of claim 9, the normalizing of the multiplication result value comprises:
selecting the greater one of magnitudes of a real part and an imaginary part of a complex number to be normalized; and
mapping the selected value through a shift operation so that the magnitude of the selected value is close to 1.

14. The phase tracking method of claim 9, wherein the calculating of the weighted mean value comprises generating a phase-compensated value by applying a phase difference value estimated in real time to a previous accumulated phase tracking value.
